(19) United States
(12) Patent Application Publication
(10) Pub. No.: US 2011/0299275 A1
(43) Pub. Date: Dec. 8, 2011

(54) Handheld Lighting Device

(75) Inventors: Rudolf Fuchs, Neuhausen (DE); Daniel Hirt, Kirchentellinsfurt (DE)

(73) Assignee: Robert Bosch GmbH, Stuttgart (DE)

(21) Appl. No.: 13/101,286

(22) Filed: May 5, 2011

(30) Foreign Application Priority Data
May 6, 2010 (DE) 102010028674.5

(51) Int. Cl. F21L 21/00; F21V 21/08; F21L 4/00

(52) U.S. Cl. 362/190; 362/427; 362/396

(57) ABSTRACT

A handheld lighting device includes a basic body and a light-emitting apparatus which is mounted such that it can pivot relative to the basic body. The handheld lighting device has a resting element which is mounted such that it can pivot relative to the basic body.

This application claims priority under 35 U.S.C. §119 to patent application no. DE 10 2010 028 674.5, filed May 6, 2010 in Germany, the disclosure of which is incorporated herein by reference in its entirety.

### BACKGROUND

The disclosure relates to a handheld lighting.

A handheld lighting device with a basic body and a light-emitting apparatus, which is mounted such that it can pivot relative to the basic body, has already been proposed.

### SUMMARY

The disclosure relates to a handheld lighting device with a basic body and a light-emitting apparatus which is mounted such that it can pivot relative to the basic body.

The disclosure proposes that the handheld lighting device has a resting element, which is mounted such that it can pivot relative to the basic body. A “basic body” should in particular be understood to mean an element which is intended to be encompassed at least partially by an operator during manual operation. Preferably, the basic body is the element of the handheld lighting device with the greatest volume. In particular, the term “light-emitting apparatus” is intended to mean an apparatus which is intended for generating a luminous flux and preferably for producing a focused emission. The phrase “mounted such that it can pivot” is intended in particular to mean that the light-emitting apparatus is connected to the basic body in such a way that it can move about an axis. In particular, a “resting element” is intended to mean an element which supports the basic body when it is positioned on a surface in a position which in particular is variable. Preferably, the resting element is in the form of a resting clip. By virtue of the configuration according to the disclosure of the handheld lighting device, it is possible for said device to be held in the hand in a particularly comfortable manner and for said device to be rested and aligned at a working location in a comfortable and simple manner.

A further configuration proposes that the light-emitting apparatus is mounted such that it can be aligned in the direction of the basic body, as a result of which the light-emitting apparatus can be used in a particularly flexible and comfortable manner. The phrase “can be aligned in the direction of the basic body” is intended in particular to mean that the light-emitting apparatus is mounted such that it can pivot into an alignment in which an angle of alignment is less than 90 degrees, advantageously less than 45 degrees. An “angle of alignment” is intended in particular to mean an angle between a central direction of the luminous flux of the light-emitting apparatus and an imaginary area, which begins at the axis of the light-emitting apparatus and intersects the basic body along its main extent. In particular, the light-emitting apparatus is mounted such that it can pivot about the axis through more than 180 degrees, advantageously through more than 270 degrees, particularly advantageously in unrestricted fashion.

Furthermore, the disclosure proposes that the resting element has a hook-shaped fastening region, as a result of which it is possible for said resting element to be suspended in an advantageous manner. A “hook-shaped fastening region” is intended in particular to mean a region which is intended for transmitting a force, in particular a tensile force, in one direction by virtue of a concave three-dimensional configuration.

In addition, the disclosure proposes that the light-emitting apparatus and the resting element are mounted such that they can pivot about axes which are aligned parallel. Different alignments of the basic body can be compensated for by the axes aligned parallel when the device is positioned using the resting element. Preferably, the light-emitting apparatus and the resting element are mounted such that they can pivot about an identical axis.

In addition, the disclosure proposes that the handheld lighting device has a locking device which locks the light-emitting apparatus in at least one position, as a result of which the light-emitting apparatus can be brought into a desired position by an operator in a manner which is structurally simple and in particular comfortable. A “locking device” is intended in particular to mean an apparatus which generates a force counteracting a movement by virtue of a pressure being applied to an uneven area in at least one operating state.

Furthermore, the disclosure proposes that the handheld lighting device has a locking device which locks the resting element in at least one position, as a result of which a particularly secure positioning is comfortably possible.

In an advantageous development of the disclosure, it is proposed that at least the basic body has an at least partially rotationally asymmetrical outer shape, as a result of which the handheld lighting device can be aligned with a working area in a particularly comfortable and reliable manner because it does not roll away when positioned and set down. A “rotationally asymmetrical outer shape” is intended in particular to mean an outer shape in which an outer contour deviates from a circle on planes, in particular perpendicular to a main extent. In particular, in this context “partially” should be understood to mean that more than 25% of the basic body, advantageously more than 50% of the basic body, particularly advantageously the entire basic body has a rotationally asymmetrical outer shape along its main extent. As an alternative or advantageously in addition, in particular an end region of the basic body could have a rotationally asymmetrical outer shape.

Furthermore, the disclosure proposes that the light-emitting apparatus has at least one LED light-emitting means. An “LED light-emitting means” is intended in particular to mean a light-emitting means with a light-emitting diode. As an alternative or in addition, the light-emitting apparatus could have an incandescent bulb, a discharge lamp and/or another light-emitting means which appears to be expedient for a person skilled in the art. Particularly efficient and uniform illumination and a particularly long life can be achieved using the LED light-emitting means.

In addition, the disclosure proposes that the handheld lighting device has an operating energy store, which comprises at least one rechargeable battery, as a result of which the handheld lighting device can advantageously be used separately from a power supply system. Advantageously, the rechargeable battery is in the form of a lithium rechargeable battery. As an alternative or in addition, the operating energy store could have a battery, a capacitor, a mechanical operating energy store and/or another operating energy store which appears to be expedient to a person skilled in the art. Preferably, the operating energy store is connected to the basic body in such a way that it can be detached by an operator, in particular without the use of tools. As an alternative, the operating energy store could be fixedly connected to the basic body.

In addition, the disclosure proposes that the operating energy store has a state-of-charge indicator, as a result of which an operator can reliably identify that the handheld lighting device is ready for use. A “state-of-charge indicator” is intended in particular to mean an apparatus which indicates a present supply of electrical energy of the rechargeable battery in a manner which can be read by an operator. Further advantages are given in the description below relating to the drawings. The drawing illustrates an exemplary embodiment of the disclosure. The drawing, the description and the claims contain numerous features in combination. One of ordinary skill in the art will expediently also consider the features individually and combine them to form expedient further combinations.

### BRIEF DESCRIPTION OF THE DRAWING

FIG. 1 shows a perspective view of a handheld lighting device according to the disclosure which stands on a standing area,

FIG. 2 shows a perspective view of the handheld lighting device shown in FIG. 1 which is suspended at an edge, and

FIG. 3 shows a perspective view of the handheld lighting device shown in FIG. 1 in a folded-shut operating state.

### DETAILED DESCRIPTION

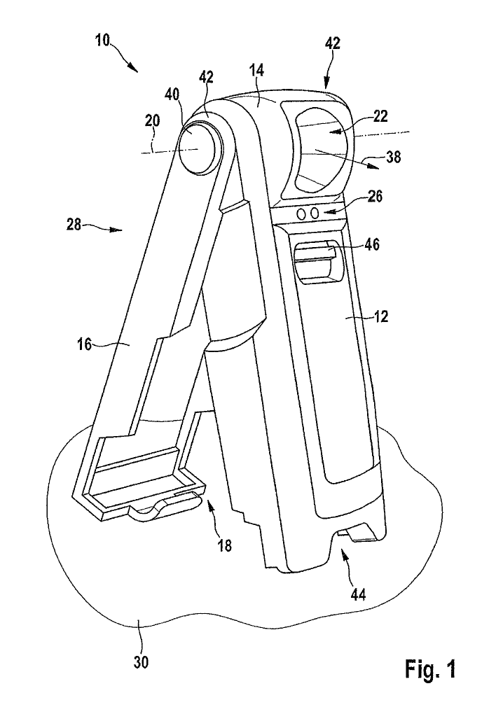

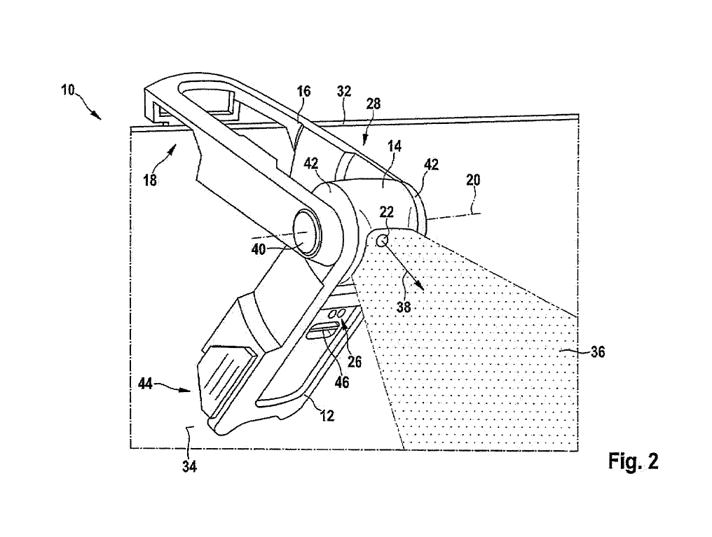

FIGS. 1 to 3 show a handheld lighting device 10 according to the disclosure with a basic body 12, a light-emitting apparatus 14 and a resting element 16. The light-emitting apparatus 14 and the resting element 16 are mounted such that they can pivot about an identical axis 20 relative to the basic body 12. Thus, the light-emitting apparatus 14 and the resting element 16 are mounted such that they can pivot about axes 20 which are aligned parallel. The axis 20 is aligned perpendicular to a main extent of the basic body 12.

The light-emitting apparatus 14 is connected directly to the basic body 12. For this purpose, the basic body 12 engages partially around the light-emitting apparatus 14. The basic body 12 and the light-emitting apparatus 14 have contact faces, which are aligned perpendicular to the axis 20 on average. The contact faces comprise a fastening region (not illustrated in any more detail) and a locking device (not illustrated in any more detail). The fastening region brings about bearing forces perpendicular to the axis and is in the form of a dome. The locking device locks the light-emitting apparatus 14 in different positions, i.e. it counteracts a rotation about the axis 20. The locking device is fine, i.e. there is an angle about the axis 20 of less than 20 degrees between the individual positions. In this exemplary embodiment, there is an angle of 5 degrees between the individual positions. Subregions of the contact faces are conductive. These subregions transmit an operating energy from the basic body 12 to the light-emitting apparatus 14. The handheld lighting device 10 has seals, which are arranged between the light-emitting apparatus 14 and the basic body 12. The seals support the contact faces. The seals are in the form of labyrinth seals. The light-emitting apparatus 14 is thus mounted in such a way that it can be aligned in the direction of the basic body 12. In addition, the light-emitting apparatus 14 is mounted such that it can rotate endlessly relative to the basic body 12. Alternatively, a cable could be passed between the light-emitting apparatus 14 and the basic body 12.

The light-emitting apparatus 14 has an LED light-emitting means 22 with an electrical input power of more than 1 watt. The LED light-emitting means 22 is mounted on a heat sink (not illustrated in any more detail). The light-emitting apparatus 14 could have further LED light-emitting means. In addition, the light-emitting apparatus 14 comprises a reflector, which focuses a luminous flux 36 emitted by the LED light-emitting means 22 about a central direction 38 of the luminous flux 36. As an alternative or in addition, the light-emitting apparatus 14 could have a lens and/or a diffuser.

The resting element 16 is connected directly to the basic body. The resting element 16 is in the form of a substantially U-shaped clip. An open region 28a of the resting element 16 surrounds the basic body 12 partially. The basic body 12 and the resting element 16 have contact faces, which are aligned perpendicular to the axis 20 on average. These contact faces comprise a locking device (not illustrated in any more detail) and a fastening region 40. The fastening region 40 is in the form of a dome of the basic body 12 and passes partially through the resting element 16. The locking device locks the light-emitting apparatus 14 in different positions. The locking device is fine. The resting element 16 supports the basic body 12 in an operating state, namely when the basic body 12 and the resting element 16 are placed on a set-down surface 30 on the sides of said basic body and resting element which face away from the axis 20.

The resting element 16 has a hook-shaped fastening region 18. The fastening region 18 is arranged on a side of the resting element 16 which faces away from the open region 28. The hook-shaped fastening region 18 points in the direction of the basic body 12 in one operating state. The resting element 16 brings about a fastening force on the basic body 12 in one operating state, namely when the hook-shaped fastening region 18 is suspended on an edge 32 and the basic body 12 bears against a face 34 arranged beneath the edge 32.

The basic body 12 has a substantially square basic shape and therefore a rotationally asymmetrical outer shape. The basic body 12 comprises two integrally formed portions 42. The integrally formed portions 42 are in the form of tongs. They have the contact faces for bearing the light-emitting apparatus 14 and the resting element 16. In addition, the basic body 12 has cut-outs 44, in which the resting element 16 is arranged in a closed operating state. The handheld lighting device 10 has a length of less than 125 mm, a width parallel to the axis 20 of less than 55 mm and a depth of less than 30 mm. The handheld lighting device 10 is thus portable and in the form of a torch.

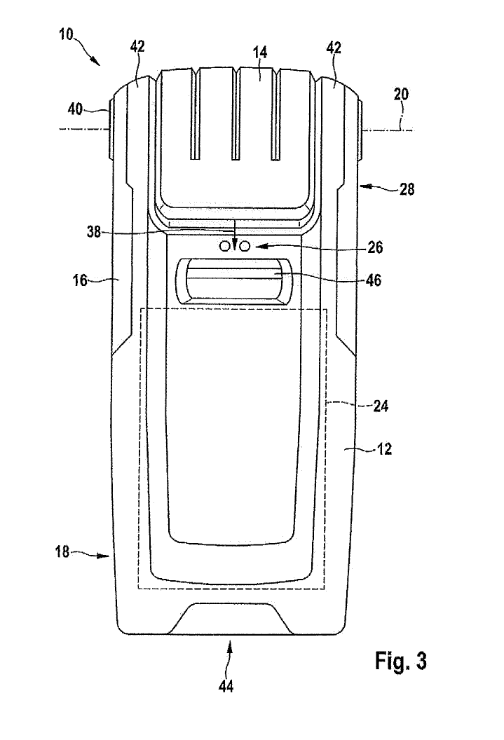

As is shown in particular in FIG. 3, the handheld lighting device 10 has an operating energy store 24. The operating energy store 24 comprises a rechargeable battery (not illustrated in any more detail). The rechargeable battery is in the form of a lithium rechargeable battery. The operating energy store 24 is integrated fixedly in the basic body 12 and can only be replaced with the aid of a tool. The operating energy store 24 has a charging terminal (not illustrated in any more detail), which draws electrical energy in at least one operating state. In addition, the operating energy store 24 has a state-of-charge indicator 26. A yellow light-emitting means of the state-of-charge indicator 26 is illuminated at a state of charge of the operating energy store 24 of between 25% and 10%. A red light-emitting means of the state-of-charge indicator 26 is illuminated at a state of charge of the operating energy store 24 of between 10% and approximately 0%.

The handheld lighting device 10 has a control element 46, which receives an operator input for switching on and off the light-emitting apparatus 14.

What is claimed is:

1. A handheld lighting device, comprising:
a basic body;
a light-emitting apparatus mounted such that it can pivot relative to the basic body; and
a resting element mounted such that it can pivot relative to the basic body.

2. The handheld lighting device according to claim 1,
wherein the light-emitting apparatus is further mounted such that it can be aligned in the direction of the basic body.

3. The handheld lighting device according to claim 1, wherein the resting element has a hook-shaped fastening region.

4. The handheld lighting device according to claim 1, wherein the light-emitting apparatus and the resting element are mounted such that they can pivot about axes which are aligned parallel.

5. The handheld lighting device according to claim 1, further comprising a locking device that is configured to lock the light-emitting apparatus in at least one position.

6. The handheld lighting device according to claim 1, further comprising a locking device that is configured to lock the resting element in at least one position.

7. The handheld lighting device according claim 1, wherein at least the basic body has an at least partially rotationally asymmetrical outer shape.

8. The handheld lighting device according to claim 1, wherein the light-emitting apparatus has at least one LED light-emitter.

9. The handheld lighting device according to claim 1, further an operating energy store configured to power the light-emitting apparatus.

10. The handheld lighting device according to claim 9, wherein the operating energy store has a state-of-charge indicator.

11. The handheld lighting device according to claim 9, wherein the operating energy store comprises at least one rechargeable battery.
